(19) United States
(12) Patent Application Publication
(10) Pub. No.: US 2025/0247933 A1
(43) Pub. Date: Jul. 31, 2025

(54) LIGHTING CONTROL SYSTEM

(71) Applicant: YAZAKI CORPORATION, Tokyo (JP)

(72) Inventors: Shohei YAMAMOTO, Shizuoka (JP); Ryo HIRAMATSU, Shizuoka (JP)

(73) Assignee: YAZAKI CORPORATION, Tokyo (JP)

(21) Appl. No.: 18/985,485

(22) Filed: Dec. 18, 2024

(30) Foreign Application Priority Data
Jan. 29, 2024 (JP) 2024-011069

(51) Int. Cl. H05B 47/16; B60J 3/04; B60Q 3/80; H05B 45/325; H05B 47/105

(52) U.S. Cl. CPC H05B 47/16; B60J 3/04; B60Q 3/80; H05B 45/325; H05B 47/105

(57) ABSTRACT

A lighting control system includes a dimming control unit configured to apply an AC voltage to a dimming unit that is provided at a predetermined portion of a region surrounding a vehicle cabin and whose light transmittance changes in response to an applied voltage, a lighting control unit configured to drive and control a lighting in the vehicle cabin in conjunction with control of the dimming control unit. The dimming unit is in a colored state when an absolute value of the applied voltage is equal to or greater than a first threshold value, and is in a transparent state when the absolute value of the applied voltage is less than the first threshold value. The lighting control unit turns off the lighting at a timing when the absolute value of the applied voltage is less than the first threshold value.

### CROSS-REFERENCE TO RELATED APPLICATIONS

This application is based on and claims priority under 35 USC 119 from Japanese Patent Application No. 2024-011069 filed on Jan. 29, 2024, the entire content of which is incorporated herein by reference.

### TECHNICAL FIELD

The present disclosure relates to a lighting control system.

### BACKGROUND ART

A lighting control system for a vehicle is known that can automate operations or reduce the number of required operations in order to create an appropriate private space within a vehicle cabin. Such a system uses, for example, a dimming glass to which a dimming film is attached that changes from colorless and transparent to colored by applying an AC voltage.

### CITATION LIST

### Patent Literature

Patent Literature 1: JP2023-031808A

When a dimming glass that changes from colorless and transparent to colored by applying an AC voltage is applied to a glass of a vehicle, a voltage of an AC voltage applied to the dimming film may decrease, and a timing may occur at which the dimming glass instantaneously becomes transparent. At such a timing, privacy may be violated in the vehicle cabin. For example, a third party may use a high-performance camera, such as a slow-motion camera, to video the inside of the vehicle cabin, and thus the inner side of the dimming glass may be videoed.

The present disclosure provides a lighting control system that can reduce the risk of privacy being violated.

### SUMMARY OF INVENTION

In order to achieve the above object, a lighting control system according to the present disclosure has the following features.

A lighting control system includes a dimming control unit configured to apply an AC voltage to a dimming unit that is provided at a predetermined portion of a region surrounding a vehicle cabin and whose light transmittance changes in response to an applied voltage, and a lighting control unit configured to drive and control a lighting in the vehicle cabin in conjunction with control of the dimming control unit. The dimming unit is in a colored state when an absolute value of the applied voltage is equal to or greater than a first threshold value, and is in a transparent state when the absolute value of the applied voltage is less than the first threshold value. The lighting control unit turns off the lighting at a timing when the absolute value of the applied voltage is less than the first threshold value.

According to the present disclosure, it is possible to reduce the risk of privacy being violated.

The present disclosure is briefly described above. Further, the details of the present disclosure can be clarified by reading a mode (hereinafter, referred to as an “embodiment”) for carrying out the disclosure to be described below with reference to the accompanying drawings.

### BRIEF DESCRIPTION OF DRAWINGS

FIG. 1 is a circuit configuration diagram of a lighting control system according to an embodiment;

FIG. 2 is a flowchart showing a procedure for dimming and lighting control that are executed by the lighting control system;

FIG. 3 is a timing chart of the driving voltage of a dimming glass and the PWM control waveform of lighting;

FIG. 4A is a conceptual diagram of a vehicle provided with the lighting control system according to the embodiment, in which the dimming glass is in a colored state;

FIG. 4B is a conceptual diagram of the vehicle provided with the lighting control system according to the embodiment, in which the dimming glass is in a transparent state and the lighting is in an off state; and

FIG. 5 is a conceptual diagram of a vehicle in the related art not provided with the lighting control system according to the embodiment, in which the dimming glass is in a transparent state and the lighting is in an on state.

### DESCRIPTION OF EMBODIMENTS

A specific embodiment of the present disclosure will be described below with reference to the drawings.

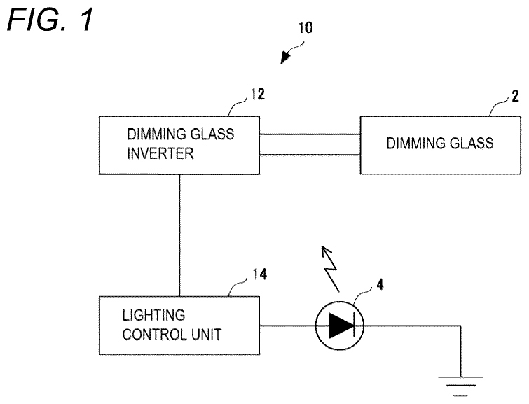

FIG. 1 is a circuit configuration diagram of a lighting control system 10 according to an embodiment. The lighting control system 10 is a system for protecting privacy inside the vehicle cabin of a vehicle while using lighting by controlling the lighting inside the vehicle cabin and the light transmittance of the glass of the vehicle. In the present disclosure, the light transmittance means the transmittance of visible light.

The lighting control system 10 includes a dimming glass inverter 12 and a lighting control unit 14. The dimming glass inverter 12 applies an AC voltage to a dimming glass 2 that is provided at a predetermined portion of a region surrounding the vehicle cabin and whose light transmittance changes in response to the applied voltage. The lighting control unit 14 drives and controls a lighting 4 in the vehicle cabin in conjunction with the control of the dimming glass inverter 12.

The dimming glass 2, which is an example of the dimming unit, is provided at a predetermined portion of the region surrounding the vehicle cabin, for example, at a position of a window glass in a door of a general vehicle. The dimming glass 2 may be provided at a position of the window glass of the rear seat. The dimming glass 2 includes, for example, a window glass for a vehicle, and a dimming film that is attached to the inner side surface or the outer side surface of the window glass or a dimming film that is sandwiched between two window glasses.

The dimming film is formed of a film-shaped dimming film whose light transmittance and light reflectance in the thickness direction can be electrically adjusted. The dimming film includes a plurality of transparent electrodes, and the light transmittance and the light reflectance change when a predetermined AC voltage is applied between the electrodes. Therefore, when an AC voltage is applied to the dimming glass 2, the dimming glass 2 changes, for example, from colorless and transparent to colored (tinted) and from colored to colorless and transparent. The dimming glass 2 does not substantially transmit visible light in a colored state, and substantially transmits visible light in a transparent state.

The dimming glass inverter 12, which is an example of a dimming control unit, is a device that converts a voltage of a DC power supply (for example, an in-vehicle battery) (not shown) of the vehicle into an AC voltage of a specific frequency (Hz), that applies the AC voltage, that is, a driving voltage, to the dimming glass 2, and drives the dimming glass 2. The dimming glass inverter 12 includes an inverter, a noise filter, and the like (not shown).

The dimming glass inverter 12 may be driven by a switch operation by a user of the vehicle to apply an AC voltage to the dimming glass 2, or may be automatically driven under a predetermined condition to apply an AC voltage to the dimming glass 2.

In the present embodiment, the dimming glass 2 is in a colored state (a tinted state) when the absolute value of the voltage applied to the dimming glass 2 by the dimming glass inverter 12 is equal to or greater than a predetermined first threshold value, and is in a transparent state when the absolute value of the applied voltage is less than the first threshold value.

The lighting 4 includes, for example, a lighting lamp (LED) and an illumination lamp (LED) that are set in the vehicle cabin, and is a light source that ensures brightness in the vehicle cabin and that creates a lighting state.

The lighting control unit 14, which is a lighting control unit, is a device that turns on the lighting 4 using, for example, general pulse width modulation (PWM) control. In the present embodiment, the lighting control unit 14 is connected to the dimming glass inverter 12. The dimming glass inverter 12 can transmit, to the lighting control unit 14, waveform information of the AC voltage to be applied to the dimming glass 2.

The lighting control unit 14 receives the waveform information of the AC voltage from the dimming glass inverter 12. Based on the received waveform information, the lighting control unit 14 executes control such that the timing at which the voltage of the dimming glass inverter 12 increases or decreases coincides with the timing at which the PWM waveform of the PWM control is turned off, that is, the lighting 4 is turned off.

That is, the lighting control unit 14 turns off the lighting 4 at a timing when the absolute value of the voltage applied to the dimming glass 2 by the dimming glass inverter 12 is less than the first threshold value described above. Control will be specifically described below.

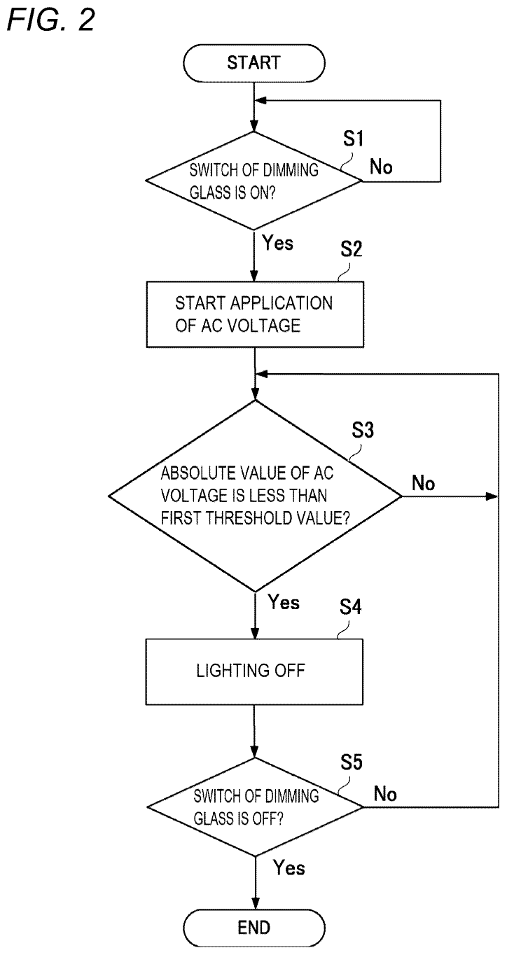

FIG. 2 is a flowchart showing a procedure for dimming and lighting control that are executed by the lighting control system 10. When the user turns on the switch of the dimming glass inverter 12 (Yes in step S1), the application of the AC voltage to the dimming glass 2 is started (step S2).

When the absolute value of the AC voltage is not smaller than the predetermined first threshold value (No in step S3), that is, when the absolute value of the AC voltage is equal to or greater than the first threshold value, the dimming glass 2 remains in the colored state. On the other hand, when the absolute value of the AC voltage is less than the predetermined first threshold value (Yes in step S3), the dimming glass 2 becomes transparent.

The lighting control unit 14 receives the waveform information of the AC voltage from the dimming glass inverter 12, and turns off the lighting 4 when the absolute value of the AC voltage becomes less than the predetermined first threshold value (step S4). When the user turns off the switch of the dimming glass inverter 12 (Yes in step S5), the processing ends. When the switch is not turned off (No in step S5), the operations from step S3 onwards are repeated. As another control pattern, the lighting control unit 14 may execute control in steps S3 to S4 only the first time the AC voltage is applied, and thereafter execute PWM control at a constant frequency (twice the frequency of the AC voltage waveform).

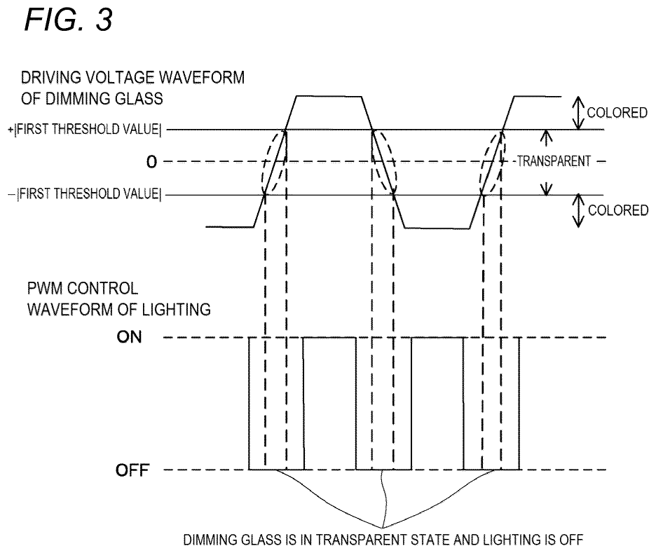

FIG. 3 is a timing chart of the driving voltage (the AC applied voltage) of the dimming glass 2 and the PWM control waveform of the lighting 4. This figure shows the procedure from step S2 onwards in FIG. 2 in the form of a timing chart.

Since the driving voltage from the dimming glass inverter 12 is an AC voltage and has an AC waveform as shown in the figure, the driving voltage fluctuates so as to repeatedly vary between the maximum value and the minimum value with zero voltage as the center. The first threshold value is an absolute value that is a turning point as to whether the dimming glass 2 is in the colored state or the transparent state. That is, when the driving voltage of the dimming glass 2 is greater than or equal to the −first threshold value and less than or equal to the +first threshold value, the dimming glass 2 is in the transparent state, and when the driving voltage of the dimming glass 2 is less than the −first threshold value or greater than the +first threshold value, the dimming glass 2 is in the colored state. The first threshold value may be, for example, zero.

The PWM control waveform by the lighting control unit 14 is a square wave that fluctuates between on and off as shown in the figure. When the control waveform indicates on, the lighting 4 is in the on state (lit), and when the control waveform indicates off, the lighting 4 is in the off state (unlit).

As shown in the figure, the lighting control unit 14 controls the lighting 4 such that the lighting 4 is in the off state at a timing when the absolute value of the voltage applied to the dimming glass 2 by the dimming glass inverter 12 is less than the first threshold value. Specifically, at a timing when the absolute value of the applied voltage is less than the first threshold value, the lighting control unit 14 executes PWM control such that the square wave indicates off, and turns off the lighting 4 (unlit).

According to the lighting control system 10 in the present embodiment, at the timing when the absolute value of the applied voltage of the AC waveform is less than the first threshold value, the dimming glass 2 is in the transparent state. However, by turning off the lighting 4 in the vehicle cabin, it becomes difficult to see inside the vehicle cabin, particularly at night when the surrounding is dark. Therefore, when the dimming glass 2, which changes from the transparent state to the colored state when an AC voltage of a predetermined value or higher is applied, is used in a part of the region surrounding the vehicle cabin, the risk of privacy being violated can be reduced even at a timing when the glass instantaneously becomes transparent due to the application of an AC voltage.

For example, when a high-performance camera (a slow-motion camera) videos the inside of the vehicle cabin with the lighting on at night when the surrounding is dark, there is a high risk that the inside of the vehicle cabin is videoed. However, according to the lighting control system 10 in the present embodiment, when the dimming glass 2, such as a so-called reverse mode dimming glass, is in the transparent state, the lighting 4 is in the off state. Therefore, the inside of the vehicle cabin becomes dark, and the risk of being videoed can be reduced.

The dimming glass inverter 12 sends information about an AC voltage waveform for controlling the dimming glass 2 to the lighting control unit 14, and the lighting control unit 14 switches the lighting 4 between the on and off states based on the information about the AC voltage waveform. By using the information about the AC voltage waveform for controlling the dimming glass 2 for control by the lighting control unit 14, it is possible to easily match the timing when the voltage of the AC voltage waveform becomes small with the timing when the lighting 4 is in the off state.

As in the embodiment, the lighting control unit 14 can switch the lighting 4 between the on and off states by PWM control based on the information of the AC voltage waveform from the dimming glass inverter 12. The frequency of the PWM waveform used in the PWM control may be set to twice the frequency of the AC voltage waveform of the dimming glass inverter 12. With such setting, the lighting 4 can be reliably turned off at a timing when the absolute value of the AC voltage becomes less than the first threshold value.

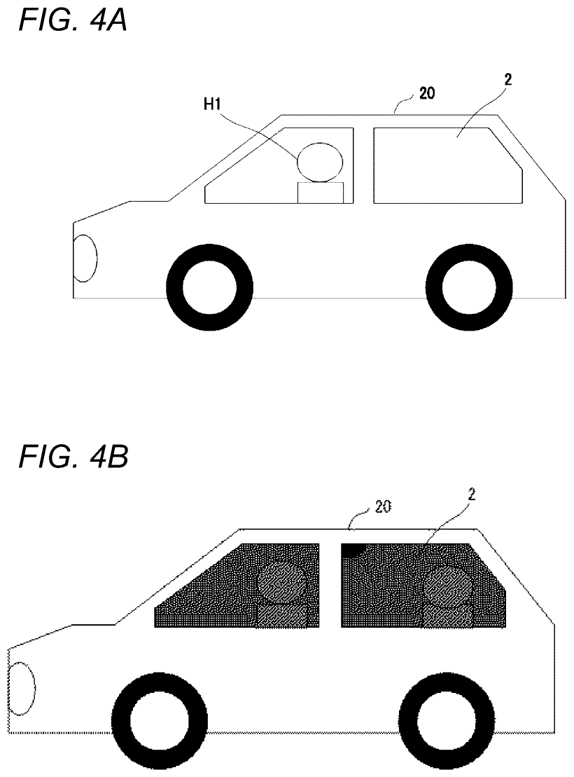

FIG. 4A is a conceptual diagram of a vehicle 20 provided with the lighting control system 10 according to the embodiment, in which the dimming glass 2 is in the colored state. FIG. 4B is a conceptual diagram of the vehicle 20 provided with the lighting control system 10 according to the embodiment, in which the dimming glass 2 is in the transparent state and the lighting 4 is in the off state.

In the vehicle 20 in this example, the window glass at the front seat is a normal window glass due to the regulation, and a passenger H1 can be seen through the window glass. On the other hand, the window glass at the rear seat is the dimming glass 2 in order to ensure privacy for the rear seat. In the state shown in FIG. 4A, the dimming glass inverter 12 applies an applied voltage having an absolute value equal to or greater than the first threshold value to the dimming glass 2, and the dimming glass 2 is in the colored state. Therefore, whether the lighting 4 is on or off, it is difficult to video the inside of the vehicle cabin at the rear seat, and privacy is ensured.

On the other hand, in the state shown in FIG. 4B, the dimming glass inverter 12 applies an applied voltage having an absolute value less than the first threshold value to the dimming glass 2, and the dimming glass 2 is in the transparent state. Then, as shown in FIG. 3, the lighting control unit 14 controls the lighting 4 such that the lighting 4 is in the off state at this timing when the absolute value of the applied voltage is less than the first threshold value. Even when the dimming glass 2 is in the transparent state, since the lighting 4 is turned off, it is difficult to video the inside of the vehicle cabin at the rear seat with a high-performance camera or the like, and it is possible to reduce the risk of privacy being violated.

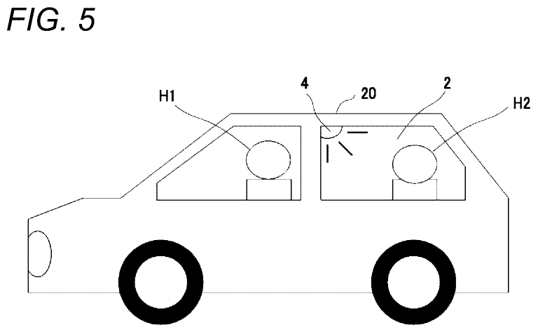

FIG. 5 is a conceptual diagram of the vehicle 20 in the related art not provided with the lighting control system 10 according to the embodiment, in which the dimming glass 2 is in the transparent state and the lighting 4 is in the on state. In the vehicle 20 in this example, the window glass at the front seat is the normal window glass, and the window glass at the rear seat is the dimming glass 2.

In FIG. 5, the dimming glass inverter 12 applies an applied voltage having an absolute value less than the first threshold value to the dimming glass 2, and the dimming glass 2 is in the transparent state. However, since the vehicle 20 is not provided with the lighting control system 10 according to the embodiment, the control as shown in FIG. 3 cannot be executed. Therefore, the dimming glass 2 is in the transparent state, the lighting 4 is in the on state, and the inside of the vehicle cabin remains bright. In this state, the inside of the vehicle cabin at the rear seat can be videoed by a high-performance camera or the like, and a passenger H2 at the rear seat can be videoed through the dimming glass 2, increasing the risk of privacy being violated.

Here, features of the lighting control system according to the above-described embodiment of the present disclosure are briefly summarized and listed in the following [1] to [3].
[1] A lighting control system (10) including:
   a dimming control unit (a dimming glass inverter 12) configured to apply an AC voltage to a dimming unit (a dimming glass 2) that is provided at a predetermined portion of a region surrounding a vehicle cabin and whose light transmittance changes in response to an applied voltage; and
a lighting control unit (a lighting control unit 14) configured to drive and control a lighting (4) in the vehicle cabin in conjunction with control of the dimming control unit,
in which the dimming unit is in a colored state when an absolute value of the applied voltage is equal to or greater than a first threshold value, and is in a transparent state when the absolute value of the applied voltage is less than the first threshold value, and
in which the lighting control unit turns off the lighting at a timing when the absolute value of the applied voltage is less than the first threshold value.

According to the lighting control system in the above [1], at the timing when the absolute value of the applied voltage is less than the first threshold value, the dimming unit is in the transparent state. However, by turning off the lighting in the vehicle cabin, it becomes difficult to see inside the vehicle cabin, particularly at night when the surrounding is dark. Therefore, it is useful when a dimming unit such as a so-called reverse mode dimming glass, which changes from the transparent state to the colored state when an AC voltage equal to or greater than a predetermined value is applied, is used in a part of the region surrounding the vehicle cabin. Specifically, when the dimming unit is used in a part of the region surrounding the vehicle cabin, the risk of privacy being violated can be reduced even at the timing when the dimming unit instantaneously becomes transparent due to the application of the AC voltage, and for example, the risk of the inside of the vehicle cabin being videoed with a high-performance camera can be reduced.
[2] The lighting control system according to the above [1],
in which the lighting control unit transmits information of an AC voltage waveform for controlling the dimming unit to the lighting control unit, and in which the lighting control unit switches the lighting between on and off states based on the information of an AC voltage waveform.

According to the lighting control system in the above [2], by using the information about the AC voltage waveform for controlling the dimming unit for control by the lighting control unit, it is possible to easily match the timing when the voltage of the AC voltage waveform becomes small with the timing when the lighting is in the off state.
[3] The lighting control system according to the above [2],
in which the lighting control unit switches the lighting between the on and off states by PWM control based on the information of an AC voltage waveform, and
in which a frequency of a PWM waveform used in the PWM control is twice a frequency of the AC voltage waveform.

According to the lighting control system in the above [3], the lighting can be reliably turned off at a timing when the absolute value of the AC voltage becomes less than the first threshold value.

What is claimed is:

1. A lighting control system comprising:
a dimming control unit configured to apply an AC voltage to a dimming unit that is provided at a predetermined portion of a region surrounding a vehicle cabin and whose light transmittance changes in response to an applied voltage; and
a lighting control unit configured to drive and control a lighting in the vehicle cabin in conjunction with control of the dimming control unit,
wherein the dimming unit is in a colored state when an absolute value of the applied voltage is equal to or greater than a first threshold value, and is in a transparent state when the absolute value of the applied voltage is less than the first threshold value, and
wherein the lighting control unit turns off the lighting at a timing when the absolute value of the applied voltage is less than the first threshold value.

2. The lighting control system according to claim 1,
wherein the lighting control unit transmits information of an AC voltage waveform for controlling the dimming unit to the lighting control unit, and
wherein the lighting control unit switches the lighting between on and off states based on the information of an AC voltage waveform.

3. The lighting control system according to claim 2,
wherein the lighting control unit switches the lighting between the on and off states by PWM control based on the information of an AC voltage waveform, and
wherein a frequency of a PWM waveform used in the PWM control is twice a frequency of the AC voltage waveform.
